(19) United States
(12) Patent Application Publication
(10) Pub. No.: US 2025/0342273 A1
(43) Pub. Date: Nov. 6, 2025

(54) BLOCKCHAIN-BASED DYNAMIC AUTHORIZATION METHOD AND SYSTEM FOR PERSONAL DATA

(71) Applicant: NATIONAL TAIWAN UNIVERSITY OF SCIENCE AND TECHNOLOGY, Taipei City (TW)

(72) Inventor: Jui-Chu LIN, Taipei City (TW)

(21) Appl. No.: 18/813,812

(22) Filed: Aug. 23, 2024

(30) Foreign Application Priority Data
May 3, 2024 (TW) 113204505
Jul. 5, 2024 (TW) 113125369

(51) Int. Cl. G06F 21/62

(52) U.S. Cl. CPC G06F 21/6245

(57) ABSTRACT

The present disclosure provides a method and a system for dynamically authorizing personal data based on a blockchain. The method includes: receiving a use requirement, submitted by a personal data requester, for using personal data of a personal data owner; notifying the personal data owner of the use requirement; receiving a grant made by the personal data owner; generating an authorization credential based on a blockchain non-fungible token and linking the authorization credential to a blockchain wallet of the personal data requester; receiving a request, submitted by the personal data requester, for accessing the personal data of the personal data owner; verifying that the blockchain wallet of the personal data requester is linked with the authorization credential created by the personal data owner; and providing the personal data stored in the blockchain to be accessed by the personal data requester after the authorization credential is successfully verified.

### CROSS-REFERENCE TO RELATED APPLICATION

The present disclosure claims the benefit of and priority to Taiwan Patent Application Serial No. 113204505 filed on May 3, 2024, entitled “AUTHORIZATION SYSTEM FOR USE OF PERSONAL INFORMATION” (hereinafter referred to as “the '505 application”) and Taiwan Patent Application Serial No. 113125369 filed on Jul. 5, 2024, entitled “METHOD AND SYSTEM FOR DYNAMICALLY AUTHORIZING PERSONAL DATA BASED ON BLOCKCHAIN” (hereinafter referred to as “the '369 application”). The disclosures of the '505 application and '369 application are hereby incorporated fully by reference into the present disclosure.

### FIELD

The present disclosure relates to management of personal data, and more particularly, to a method and a system for a personal data owner to dynamically authorize others to use his personal data.

### BACKGROUND

In today's cloud-based Internet age, all kinds of personal data about people are continuously being collected and utilized. Such collection and utilization of personal data is sometimes done with people's consent. For example, when people use certain web services, they are asked to create an account and provide personal data such as date of birth, address, gender, occupation, etc. However, some types of personal data, such as health-related data like medical records, clinical treatment, and physical examination, as well as tax-related data like income and expenditures, are often collected, recorded, and utilized by relevant institutions (e.g., health insurance institutions or medical institutions).

With the continuous advancement of big data and artificial intelligence technologies, personal data, particularly those involving privacy as mentioned above, is often analyzed and utilized by academic institutions to formulate or develop beneficial research outcomes and industry applications according to their analysis results. For example, with a primary goal of developing a precision health strategy industry for the future, it is expected that a precision healthcare system, focusing on early detection of cancers, early treatment and reduction of mortality, can be established in the coming years. However, such a goal requires a big data sharing platform and mechanism related to a vast amount of personal health data. However, since the personal data collected and stored by these relevant organizations involves personal privacy, there is room for improvement on having the personal data available while ensuring the protection of personal privacy has become a top issue.

The blockchain, gaining popularity in recent years, provides a secure and viable data-sharing technology. The blockchain is a distributed database technology, the core concept of which is to wrap data into blocks. Each block includes a unique hash value calculated from its own data and the hash value of the previous block, thus being chained into chain(s). These chains are stored in multiple copies in a decentralized peer-to-peer network. This design makes the content of blocks difficult to tamper with. Therefore, storing personal data in the blockchain can provide sharing while ensuring the security of the personal data. However, the blockchain itself cannot provide an individual with the right to autonomously control the privacy of his personal data, that is, it is up to the individual to decide whether to disclose his personal data, and if so, to whom, within what scope, when, and in what way.

### SUMMARY

The present disclosure provides a personal data use authorization system. Based on de-identification, blockchain and credential signature technologies, the system can return the ownership of personal data to a user while ensuring the participant's right to opt out, thus allowing secondary authorization and utilization of de-identified data corresponding to the personal data to safeguard the personal intension of a personal data provider.

The personal data use authorization system provided by the present disclosure includes a dynamic consent form subsystem, a credential management subsystem, a de-identification subsystem and a blockchain subsystem. The dynamic consent form subsystem is configured to provide a dynamic consent form for authorizing the use of personal data. The credential management subsystem is coupled to the dynamic consent subsystem and configured to provide an authorization credential for the dynamic consent form. The de-identification subsystem is coupled to the dynamic consent form subsystem and a personal data database and configured to perform de-identification for the personal data to obtain de-identified data and provide the de-identified data according to an authorized use of the personal data. The blockchain subsystem is coupled to the dynamic consent form subsystem and the de-identification subsystem and configured to record a hash value of the dynamic consent form, the authorization credential, and hash values of the personal data and the de-identified data.

In an embodiment of the present disclosure, the dynamic consent form subsystem includes a human-machine interface and a dynamic consent form module. The human-machine interface is configured to fill in the content of the dynamic consent form. The dynamic consent form module is coupled with the human-machine interface and configured to fill in through the human-machine interface the content of the dynamic consent form, calculate the hash value of the dynamic consent form, and integrate the dynamic consent form with the authorization credential.

In an embodiment of the present disclosure, the dynamic consent form subsystem further includes an intention change module. The intention change module is coupled with the human-machine interface and the dynamic consent form module and configured to change the content of the dynamic consent form, calculates the hash value of the changed dynamic consent form, and integrates the changed dynamic consent form with the authorization credential through the human-machine interface.

In an embodiment of the present disclosure, the credential management subsystem includes a human-machine interface and a credential signing module. The human-machine interface is configured to provide options for selecting a credential source. The credential signing module is coupled with the human-machine interface and configured to execute an electronic signature according to a credential to generate an authorization credential.

In an embodiment of the present disclosure, the credential management subsystem further includes an authority credential management module, a system self-issued credential management module, and a private credential management module. The authority credential management module is coupled with the human-machine interface and configured to manage credentials issued by the authority. The system self-issued credential management module is coupled with the human-machine interface and configured to manage the credentials issued by the personal data use authorization system. The private credential management module is coupled to the human-machine interface and configured to manage personal private credentials.

In an embodiment of the present disclosure, the de-identification subsystem includes a de-identification database. The de-identification database is configured to store the de-identified data.

In an embodiment of the present disclosure, the de-identification subsystem calculates a hash value based on the personal data and corresponding de-identified data.

In an embodiment of the present disclosure, the blockchain subsystem includes a blockchain uploading module and a blockchain. The blockchain uploading module is configured to upload the hash value of the dynamic consent form, the authorization credential, and the hash values of the personal data and the de-identified data. The blockchain is coupled to the blockchain uploading module and configured to store the hash value of the dynamic consent form, the authorization credential, and the hash values of the personal data and the de-identified data.

The present disclosure employs technologies such as the dynamic consent form, the credential management, the de-identification, and the blockchain and thus allows secondary authorization and utilization of de-identified data corresponding to the personal data to safeguard the personal intension of a personal data provider.

Another objective of the present disclosure is to provide a novel method for providing an individual to control his personal data dynamically and autonomously, that is, it is up to the individual to decide whether to disclose his personal data, and if so, to whom, within what scope, when, and in what way, as well as to dynamically modify these authorization conditions.

Therefore, the present disclosure provides a method for dynamically authorizing personal data based on a blockchain, enabling a personal data owner to dynamically authorize a personal data requester to access personal data stored in the blockchain. The method includes the following steps:
receiving a use requirement, submitted by the personal data requester through a requirement application interface, for using the personal data of the personal data owner;
notifying the personal data owner of the use requirement;
receiving a grant made by the personal data owner through a use authorization interface;
generating an authorization credential based on a blockchain non-fungible token and linking the authorization credential to a blockchain wallet of the personal data requester;
submitting a request, by the personal data requester through a personal data access interface, for accessing the personal data of the personal data owner;
verifying, by the personal data access interface, that the blockchain wallet of the personal data requester is linked with the authorization credential created by the personal data owner; and
providing, by the personal data access interface, the personal data stored in the blockchain to be accessed by the personal data requester after the authorization credential is successfully verified.

In some embodiments of the present disclosure, the present disclosure further includes the following steps:
automatically burning, by the personal data access interface, the authorization credential when the personal data access interface discovers that the authorization credential is invalid;
receiving a request, submitted by the personal data owner through the use authorization interface, for burning the authorization credential; and
burning the authorization credential.

In an embodiment of the present disclosure, the blockchain is a public blockchain, a private blockchain, a hybrid blockchain, or a consortium blockchain. In addition, the blockchain may include a single chain or multiple chains.

In an embodiment of the present disclosure, the authorization credential is preferably a non-tradable soul-bound non-fungible token.

The above and other objectives and advantages of the present disclosure will be described in detail in the following description of the embodiments with reference to the accompanying drawings and claims. It should be understood that the drawings are merely for the purpose of illustrating the spirit of the present disclosure and are not to be construed as defining the scope of the present disclosure. For definitions pertaining to the scope of the present disclosure, reference should be made to the appended claims.

### BRIEF DESCRIPTION OF THE DRAWINGS

In order to make the above and other objects, features, advantages and embodiments of the present disclosure more readily understood, the accompanying drawings are described as follows:

FIG. 1 is a schematic diagram of a personal data use authorization system according to an embodiment of the present disclosure.

FIG. 2 is a schematic diagram of a dynamic consent form subsystem according to an embodiment of the present disclosure.

FIG. 3 is a schematic diagram of a credential management subsystem according to an embodiment of the present disclosure.

FIG. 4 is a schematic diagram of a de-identification subsystem according to an embodiment of the present disclosure.

FIG. 5 is a schematic diagram of a blockchain subsystem according to an embodiment of the present disclosure.

FIG. 6 is a flowchart illustrating a method provided by the present disclosure for dynamically authorizing personal data based on a blockchain.

FIG. 7 is a schematic diagram of a system provided by the present disclosure for dynamically authorizing personal data based on a blockchain.

### DETAILED DESCRIPTION OF THE PREFERRED EMBODIMENTS

In the present disclosure, “a,” “an,” and “the” may refer to a singular form or a plural form, unless an article is specifically restricted to be a singular form in the context.

In addition, as used herein, the terms “comprise/comprising,” “include/including,” “have/having,” and the like are open-ended terms that imply the inclusion of the disclosed features, elements and/or components, but do not preclude the presence or addition of one or more other features, elements, components, and/or groups thereof.

The term “coupled” used in the present disclosure may indicate that two or more elements or devices are in direct physical contact with each other or in indirect physical contact with each other, and may also indicate that two or more elements or devices cooperate or interact with each other.

Furthermore, the ordinal terms (such as “first,” “second,” “third,” and the like) used in the present disclosure and claims are used to modify an element itself and do not imply any priority or any order of one element over another element, or do not imply a chronological order of steps of a method performed, but are used only as symbols to distinguish a claimed element having a particular name from another element having the same name.

The spirit of the present disclosure will be clearly illustrated with drawings and detailed descriptions below. After understanding the embodiments of the present disclosure, those skilled in the art with ordinary knowledge can make modifications and variations based on the technologies taught in the present disclosure without departing from the spirit and scope of the present disclosure.

The term “personal data” as referred to in the present disclosure refers to the data that meets the definition of personal data protection and includes data such as name, date of birth, characteristics, fingerprints, marriage, family, education, occupation, medical records, medical treatment, genetic information, sexual life, physical examination, criminal records, contact information, financial situation, social activities, and other data that can identify an individual directly or indirectly. The individual is referred to as “a personal data owner” for the present disclosure.

The personal data of one or more personal data owners has been added to and stored in a blockchain by a “personal data administrator” in accordance with a block building procedure, also known as mining, for blockchain. The related building procedure should belong to the prior art and will not be described in detail herein. The term “personal data administrator” as referred to in the present disclosure refers to an institution responsible for collecting, managing, or maintaining personal data (e.g., a healthcare institution, a medical institution, a financial institution, or an operator responsible for a biological database).

The blockchain may be a public blockchain (that is, a blockchain that does not require permission and is available to the general public), a private blockchain (that is, a blockchain that is privately controlled and not open to the public), a consortium blockchain (that is, a blockchain that is only accessible to a predetermined number of organizations or institutions), or a hybrid blockchain (that is, a combination of public and private blockchains). The blockchain may include a single chain or multiple chains.

An individual or an institution that intends to utilize the personal data stored in the blockchain is referred to as “a personal data requester” in the present disclosure. The personal data requester of personal data needs to have permission to utilize the blockchain and thus has his/its own exclusive “wallet” on the blockchain. A so-called blockchain wallet is a unique address, which functions like an account of a network service, and is a digital asset and management mechanism on the blockchain. The main functions of the blockchain wallet include generating and managing cryptographic key pairs (public and private keys), signing transactions, etc. With the unique address, the blockchain wallet can be used to transmit and receive cryptocurrencies (e.g., Bitcoin and Ether) as well as the dynamic authorization of the personal data owner as provided by the present disclosure. The blockchain wallet building procedure should belong to the prior art and will not be described in detail herein.

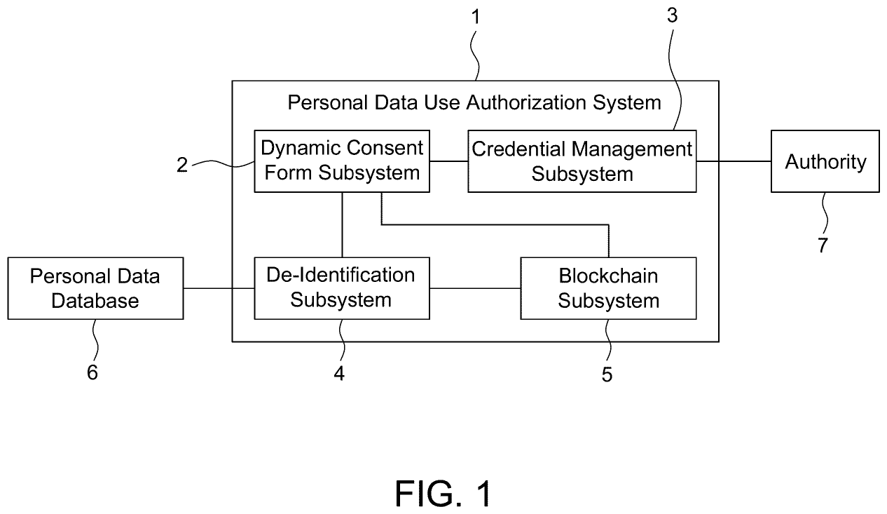

Referring to FIG. 1, a schematic diagram of a personal data use authorization system according to an embodiment of the present disclosure is shown. The system 1 provided by the embodiment of the present disclosure may include at least one of cloud server, computer, and computing device including hardware, software, or a combination of hardware and software for executing, calculating, and storing information and data. The present embodiment provides a personal data use authorization system 1. The system 1 includes a dynamic consent form subsystem 2, a credential management subsystem 3, a de-identification subsystem 4, and a blockchain subsystem 5. The credential management subsystem 3 is coupled to the dynamic consent form subsystem 2. The de-identification subsystem 4 is coupled to the dynamic consent form subsystem 2 and a personal data database 6. The blockchain subsystem 5 is coupled to the dynamic consent form subsystem 2 and the de-identification subsystem 4. Specifically, the functions of the subsystems in the system 1 are described as follows. The dynamic consent form subsystem 2 is configured to provide a dynamic consent form for authorizing the use of personal data. The credential management subsystem 3 is configured to provide an authorization credential for the dynamic consent form. The de-identification subsystem 4 is configured to perform de-identification for the personal data to obtain de-identified data and provide the de-identified data according to an authorized use of the personal data. The blockchain subsystem 5 is configured to record a hash value of the dynamic consent form, the authorization credential, and hash values of the personal data and the de-identification data. In addition, it should be noted that the dynamic consent form is provided to a personal data provider for signing and modifying the authorization content for the use of his personal data, thus ensuring that the personal data is utilized legally within the scope of the provider's consent.

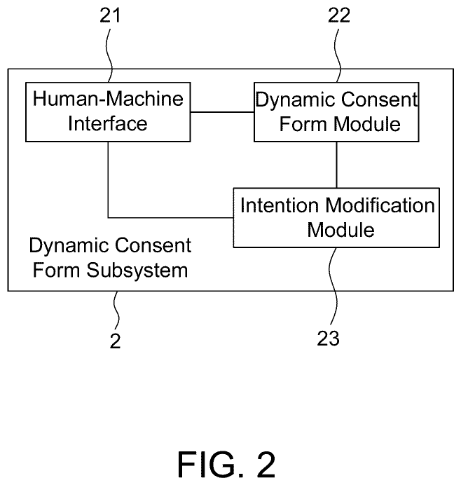

FIG. 2 is a schematic diagram of a dynamic consent form subsystem according to an embodiment of the present disclosure. The dynamic consent form subsystem 2 provided by the present embodiment includes a human-machine interface 21, a dynamic consent form module 22, and an intention change module 23. The dynamic consent form module 22 is coupled to the human-machine interface 21. The intention change module 23 is coupled to the human-machine interface 21 and the dynamic consent form module 22. Specifically, the functions of the interface and modules in the dynamic consent form subsystem 2 are described as follows. The human-machine interface 21 is configured to fill in the content of the dynamic consent form. The dynamic consent form module 22 is configured to fill in through the human-machine interface the content of the dynamic consent form, calculate the hash value of the dynamic consent form, and integrate the dynamic consent form with the authorization credential.

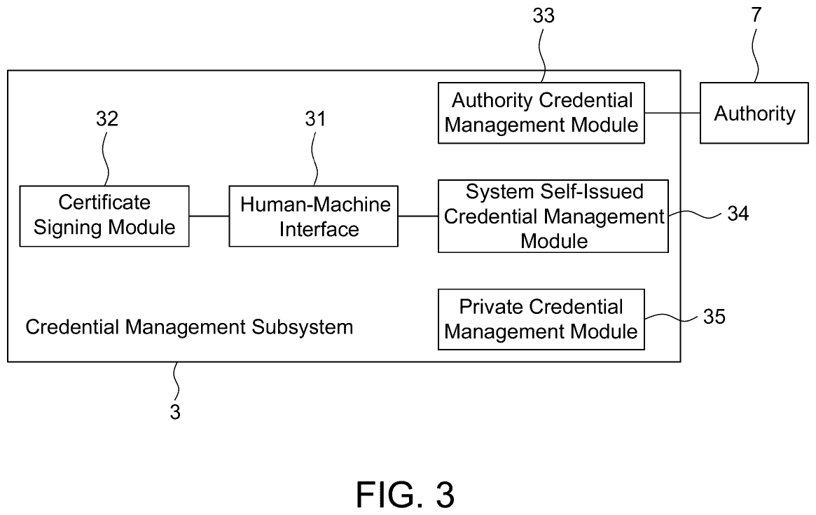

FIG. 3 is a schematic diagram of a credential management subsystem according to an embodiment of the present disclosure. The credential management subsystem 3 provided by the present embodiment includes a human-machine interface 31, a credential signing module 32, an authority credential management module 33, a system self-issued credential management module 34, and a private credential management module 35. The credential signing module 32 is coupled to the human-machine interface 31. The authority credential management module 33 is coupled to the system self-issued credential management module 34. The system self-issued credential management module 34 is coupled to the human-machine operation interface 31 and the private credential management module 35. Specifically, the functions of the interface and modules in the credential management subsystem 3 are described as follows. The human-machine interface 31 is configured to provide options for selecting a credential source. The credential signing module 32 is configured to execute an electronic signature according to a credential to generate an authorization credential. The authority credential management module 33 is configured to manage credentials issued by an authority 7. The system self-issued credential management module 34 is configured to manage the credentials issued by the personal data use authorization system. The private credential management module 35 is configured to manage personal private credentials.

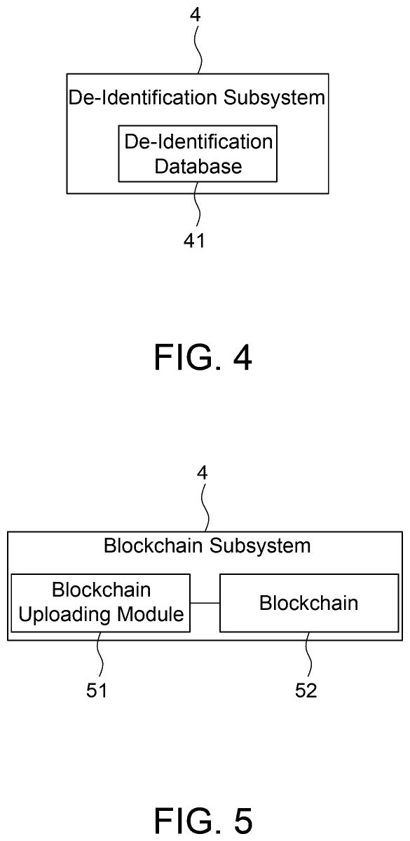

FIG. 4 is a schematic diagram of a de-identification subsystem according to an embodiment of the present disclosure. The de-identification subsystem 4 provided by the present embodiment includes a de-identification database 41. The de-identification subsystem 4 is configured to calculate a hash value based on the personal data and corresponding de-identified data, and the de-identification database 41 is configured to store the de-identified data.

FIG. 5 is a schematic diagram of a blockchain subsystem according to an embodiment of the present disclosure. The blockchain subsystem 5 provided by the present embodiment includes a blockchain uploading module 51 and a blockchain 52. The blockchain 52 is coupled to the blockchain uploading module 51. Specifically, the functions of the modules in the blockchain subsystem 5 are described as follows. The blockchain uploading module 51 is configured to upload the hash value of the dynamic consent form, the authorization credential, and the hash values of the personal data and the de-identified data. The blockchain 52 is configured to store the hash value of the dynamic consent form, the authorization credential, and the hash values of the personal data and the de-identified data.

In one exemplary embodiment, a personal data provider participates in a healthcare big data program, and the program can safeguard the usage right of the personal data of the personal data provider through the personal data use authorization system 1 of the present disclosure. After the personal data provider registers with the personal data use authorization system 1 of the present disclosure, the system self-issued credential management module 34 of the credential management subsystem 3 of the present disclosure generates a self-issued credential for the personal data provider to use. After the personal data provider logs in the personal data use authorization system 1 of the present disclosure, the dynamic consent form module 22 of the dynamic consent form subsystem 2 of the present disclosure provides to the personal data provider a dynamic consent form for personal data through the human-machine interface 21, so as to fill in the content of the dynamic consent form. Moreover, after the content of the dynamic consent form is completely filled in, the personal data provider can select a credential from the authority credential management module 33, the system self-issued credential management module 34, and the private credential management module 35 through the human-machine interface 31 of the credential management subsystem 3, and then execute an electronic signature according to the credential through the credential signing module 32 to generate an authorization credential. The dynamic consent form module 22 of the dynamic consent form subsystem of the present disclosure 2 then calculates the hash value of the dynamic consent form and integrates the dynamic consent form with the authorization credential, so as to upload the hash value of the dynamic consent form and the authorization credential to the blockchain 52 through the blockchain uploading module 51 of the blockchain subsystem 5 of the present disclosure. After the personal data provider completes the execution of a signature on the dynamic consent form, the personal physical examination is collected by a hospital, and the personal physical examination is analyzed by the program to generate analyzed personal health data, which is then stored in a personal data database 6. When the personal data provider consents to authorize the use of the personal data, the de-identification subsystem 4 of the present disclosure de-identifies the personal data of the personal data provider to generate de-identified data and calculates a hash value based on the personal data and the corresponding de-identified data. For example, a medical record number in the personal data is replaced with a meaningless unique code, and the personal data and the replaced information can be additionally recorded in the personal data use authorization system 1 of the present disclosure. In addition, the de-identification database 41 of the de-identification subsystem 4 of the present disclosure stores the de-identified data. Then, the hash values of the personal data and the de-identified data are uploaded to the blockchain 52 through the blockchain uploading module 51 of the blockchain subsystem 5 of the present disclosure. If, at a later day, the health big data program utilizes the data of the personal data provider for analysis and makes unexpected findings, such as potential major disease risk, the de-identified data can be re-linked with the personal data of the personal data provider through the personal data use authorization system 1 of the present disclosure. Meanwhile, the data processed by the personal data use authorization system 1 of the present disclosure may be stored in other databases for reuse of health data of the present program.

In another exemplary embodiment, when the personal data provider intends to modify a certain part of the content of the dynamic consent form previously filled in by the program, the personal data provider logs into the personal data use authorization system 1 of the present disclosure, selects the signed dynamic consent form through the human-machine interface 21 by the intention modification module 23, and adjusts the intended modification in the dynamic consent form. Afterwards, the adjusted and modified dynamic consent form will be transmitted to the dynamic consent form module 22. Moreover, after the content of the modified dynamic consent form is completely filled in, the personal data provider can select a credential from the authority credential management module 33, the system self-issued credential management module 34, and the private credential management module 35 through the human-machine interface 31 of the authorization credential management subsystem 3, and then sign an electronic signature according to the certificate through the certificate signing module 32 to generate an authorization credential, thereby completing a signed document. The dynamic consent form module 22 of the dynamic consent form subsystem of the present disclosure 2 then calculates the hash value of the modified dynamic consent form and integrates the modified dynamic consent form with the authorization credential, so as to upload the hash value of the modified dynamic consent form and the authorization credential to the blockchain 52 through the blockchain uploading module 51 of the blockchain subsystem 5 of the present disclosure.

In a further exemplary embodiment, when the personal data provider wishes to withdraw from the program due to a change in personal intention, the personal data provider logs into the personal data use authorization system 1 of the present disclosure, selects the signed dynamic consent form through the human-machine interface 21 by the intention modification module 23, and adjusts the intended modification (i.e., opt out) in the dynamic consent form. Afterwards, the adjusted and modified dynamic consent form will be transmitted to the dynamic consent form module 22, and an exit record information for the dynamic consent form is generated and subsequently uploaded to the blockchain 52 by the blockchain uploading module 51 of the blockchain subsystem 5 of the present disclosure, thus allowing the personal data provider to check and verify the exit record information later.

In summary, the system provided by the present disclosure for authorizing the use of personal data employs technologies such as the dynamic consent form, the credential management, the de-identification, and the blockchain and thus allows secondary authorization and utilization of de-identified data corresponding to the personal data to safeguard the personal preference of a personal data provider.

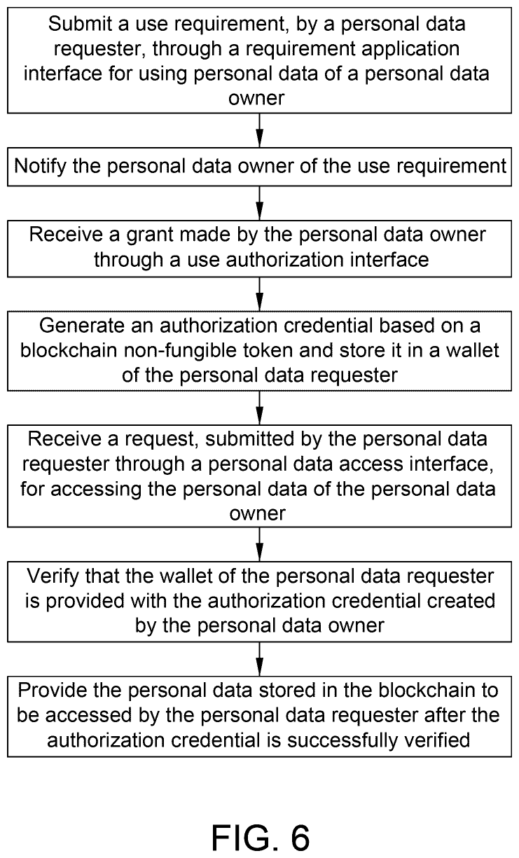

Referring to FIG. 6, the steps of the method provided by the present disclosure for dynamically authorizing personal data based on a blockchain will be described in detail below.

First, the present disclosure provides a requirement application interface for a personal data requester to apply for a “use requirement” for using personal data of a personal data owner. The “use requirement” referred to in the present disclosure includes, but is not limited to, the identity data of the personal data requester, the scope of personal data to be used (e.g., specific parts or entirety), the purpose of use, the date and time range for use, and the number of times of use. The present disclosure provides a use authorization interface for the personal data owner to either consent to or reject the use requirement for using of the personal data and also for the personal data owner to modify the use requirement (for example, modifying the scope of personal data, the date and time range for use, and the number of times of use) and consent to the modified use requirement.

The requirement application interface and the use authorization interface are preferably, but not limited to be, provided by a decentralized application (DApp). The decentralized application is an application built on blockchain technology. Unlike the traditional centralized application, the decentralized application stores and processes data across multiple nodes in a blockchain network during operation without relying on a single centralized server. Since the data storage and data processing are performed across multiple nodes with encryption technology utilized, the decentralized application is highly secure.

The architecture of the decentralized application is divided into a front end (i.e., the aforementioned requirement application interface, the use authorization interface, etc.) and a back end (e.g., a smart contract, which will be described below). The interface at the front end is not stored in the blockchain and may be (but not limited to) a conventional web application (serving one or more web pages) using technologies such as HTML, CSS, and JavaScript and running on a traditional or decentralized web server. The smart contract at the back end is responsible for handling business logic, data storage, and transaction processing and stored in the blockchain with each node having a copy stored thereon.

The decentralized application and the smart contract, which will be described later in the present disclosure, are important mechanisms for the blockchain. In the present disclosure, the requirement application interface and the use authorization interface provided by the decentralized application allows the personal data requester and the personal data owner to interact with a smart contract on the blockchain and use the functions thereof. Specifically, the personal data requester or the personal data owner can access the requirement application interface or the use authorization interface of the front end through a web browser on a mobile phone, a computer, or other device and then interact with a smart contract of the back end through these interfaces. The smart contract at back end receives the request, executes the corresponding business logic, and returns a result to the interface at front end. At the same time, all transactions and state changes are recorded and broadcast to all nodes in the blockchain.

Next, as shown in FIG. 6, the present disclosure receives a use requirement, submitted by a personal data requester through the requirement application interface, for using the personal data of the personal data owner. After the use requirement is submitted, it will be reviewed by a personal data administrator. The present disclosure may also provide an administrator review interface. Similar to the requirement application interface or the use authorization interface described above, the administrator review interface is also based on the decentralized application. The related details will not be reiterated.

After the use requirement is approved by the personal data administrator, the present disclosure then notifies the relevant personal data owner of the use requirement. The notification can be sent to the personal data owner by means of e-mail, short message, etc., and the notification includes not only the content of the use requirement, but also the link for accessing the use authorization interface.

The personal data owner consents to or rejects the use requirement or consents to the modified use requirement through the use authorization interface. If the personal data owner consents to the use requirement (or the modified use requirement), the smart contract corresponding to the use authorization interface then generates an authorization credential based on a blockchain token and “stores” the authorization credential in the blockchain wallet of the personal data requester. The authorization credential records the content of the aforementioned use requirement (or the modified use requirement), such as the scope of personal data to be used, the date and time range for use, the number of times of use, etc. The term “store” is colloquially used here and, more precisely, is meant to link the authorization credential to a unique address of the blockchain wallet.

Tokens are mechanisms issued, managed, transferred, and traded on the blockchain and represent various assets or values. Tokens include currencies (e.g., Bitcoin and Ether), physical assets (e.g., gold, real estate and art), specific interests or functions (e.g., voting right and access right), etc. Tokens can use blockchain technology to ensure security and transparency and can be tracked and recorded on the blockchain to ensure the authenticity and immutability of the issuance, management, transfer, and transaction of the tokens.

The authorization credential belongs to a non-fungible token (NFT). Unlike cryptocurrency tokens (e.g., Bitcoin and Ether), a non-fungible token (NFT) cannot be exchanged for one another as each NFT has a unique identity. Therefore, the authorization credential generated by each personal data owner, based on a non-fungible token, for consenting to each use requirement of each personal data requester is unique and non-interchangeable.

Preferably, the authorization credential further belongs to a special type of non-tradeable and non-transferable token known as a soul-bound NFT. The term “soul-bound” implies a close connection between a non-fungible token and its holder, and the holder having the non-fungible token possesses a special right to a corresponding asset.

As described above, the creation and management of the authorization credential is completed by a smart contract provided by the present disclosure. The smart contract is an automated computer program executed on a blockchain and includes pre-written program codes that automatically run to implement predefined business logic and track related transactions and decisions when specific conditions are met. The smart contract is generally used to manage digital assets (such as aforementioned tokens), execute transactions, enable decentralized services, etc.

The program codes for a smart contract is typically stored on each node of the blockchain with each node having an identical copy of the smart contract. When a smart contract is deployed on a blockchain, its program codes and initial state are recorded in a block and broadcast across an entire blockchain network. Each participating node receives and stores the program codes and states of the smart contract in a local storage. Therefore, each node has an identical copy of the smart contract. When the smart contract is triggered to be executed, each node executes the same contract program codes and updates states based on execution results. These results are also broadcast across the entire blockchain network and are verified and recorded by each node. In this way, the states and operation results of the smart contract can be verified and recorded on all nodes of the blockchain network, thus ensuring its transparency, security and immutability.

If the personal data owner consents to the use requirement, the use authorization interface activates a corresponding smart contract, creates a non-fungible token representing the authorization credential and links the authorization credential to the blockchain wallet of the personal data requester. In other words, the decentralized application of the use authorization interface is an interface for the personal data owner to interact with the blockchain, and the smart contract is the program codes that implements the business logic and function behind the decentralized application. It should be noted that the smart contract can be shared by multiple decentralized applications and cannot be limited to a single decentralized application.

The states and transaction records of the creation, transfer, and burn of the authorization credential based on the blockchain token are stored in the blockchain with a portion of the state of the smart contract on each node. Consequently, each node in the blockchain has a copy of these pieces of information.

The blockchain wallet of a personal data requester is linked with an authorization credential created by a personal data owner, which means that the personal data requester has obtained the authorization of the personal data owner to use the personal data of the personal data owner. The personal data requester accesses the personal data of the personal data owner through a personal data access interface provided by the present disclosure. Similar to the requirement application interface and the use authorization interface, the personal data access interface is also preferably at the front end of a decentralized application and will operate by invoking a corresponding smart contract. This smart contract of the personal data access interface and the smart contracts of the personal data application interface and the use authorization interface can be included in a single smart contract or can be different smart contracts.

Therefore, when a personal data requester submits a request for accessing to the personal data of a personal data owner through the personal data access interface, the personal data access interface invokes a corresponding smart contract, which will verify that the blockchain wallet of the personal data requester is linked to the authorization credential created by the personal data owner and whether the access complies with the content of the use requirement (e.g., the scope of personal data to be used, the date and time range for use, the number of times of use, etc.) recorded in the authorization credential. Then, after the access is verified by the smart contract, the smart contract decrypts and combines relevant personal data stored in the blockchain and then provides the decrypted and combined data to the personal data requester through the personal data access interface.

When the smart contract discovers that an authorization credential stored in the blockchain wallet of the personal data requester has been invalid (for example, the recorded date and time range for use has been exceeded or the number of uses has been reached), the smart contract will automatically burn the token of the authorization credential. Burning a token on the blockchain refers to permanently removing the token from circulation usually by transmitting the token to a special address known as a burn address or a zero address. Once the token is transmitted to the address, it can no longer be used since its private key is no longer available, resulting in the token being permanently lost. Burning a token is an irreversible operation. Therefore, once a token is burned, it is impossible to recover.

In addition to the automatic burn of invalid authorization credential by the smart contract through the personal data access interface, a personal data owner may also submit a request for cancelling the previously created and still-invalid use authorization at any time through the use authorization interface. In the present embodiment, the token of the created use authorization is also burned through the smart contract of the use authorization interface.

Furthermore, a personal data requester can modify the created and still-valid use authorization (for example, modifying the scope of personal data, the date and time range for use, and the number of times of use) at any time through the aforementioned use authorization interface. In the present embodiment, the smart contract of the use authorization interface first burns the token of the previously created use authorization and then creates a new authorization credential based on a blockchain token and links the new authorization credential to the blockchain wallet of the personal data requester. The new authorization credential records the content of the modified use requirement, such as the scope of personal data to be used, the date and time range of use, the number of times of use, etc.

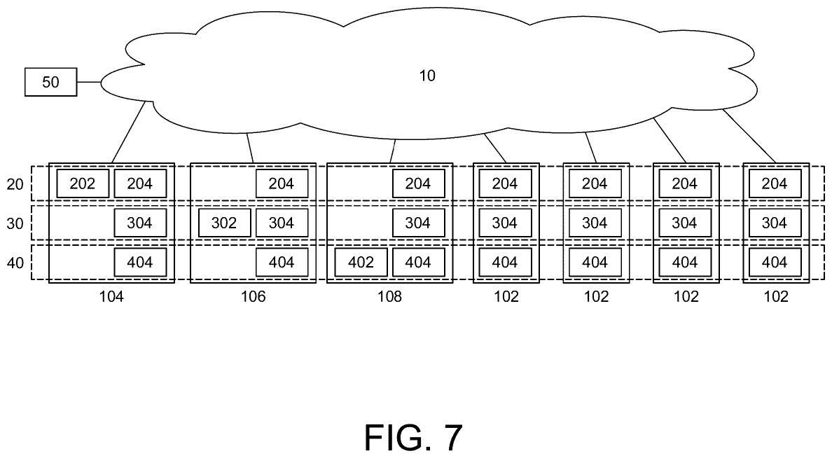

The present disclosure further provides a system for implementing the dynamic authorization of the personal data. As shown in FIG. 7, the system includes the following components:

A blockchain 10 includes a plurality of distributed and network-connected nodes 102. The blockchain can be a public blockchain, a private blockchain, a hybrid blockchain, or a consortium blockchain. The blockchain may also include a single chain or multiple chains. The personal data of a personal data owner has been added to and stored in the nodes 102 of the blockchain by a personal data administrator in accordance with a block building procedure for blockchain.

A first decentralized application 20 includes a requirement application interface 202 at a front end and a first smart contract 204 at a back end. The requirement application interface 202 runs on a first server 104 for a personal data requester to apply for a use requirement for using the personal data of the personal data owner. The first server 104 is one of the nodes 102 and may be a web server, and the requirement application interface is a web application running on the web server. The personal data requester accesses the web application through a web browser on a mobile phone, a computer or other device to use the authorization application interface 202.

A second decentralized application 30 includes a use authorization interface 302 at a front end and a second smart contract 304 at a back end. The use authorization interface 302 runs on a second server 106 for the personal data owner to either consent to or reject the use requirement for using the personal data or for the personal data owner to modify the use requirement and consent to the modified use requirement. The second server 106 is one of the nodes 102 and may be a web server, and the use authorization interface is a web application running on the web server. The personal data owner accesses the web application through a web browser on a mobile phone, a computer or other device to use the use authorization interface 302.

The first server 104 and the second server 106 can be included in a single server. The first smart contract 204 and the second smart contract 304 can be included in a single smart contract. The first smart contract 204 and the second smart contract 304 are stored in the blockchain with a copy stored on each node 102.

When the first smart contract 204 is activated through the requirement application interface 202, the first smart contract 204 transmits the use requirement to a personal data administrator. After the use requirement is approved by the personal data administrator, the first smart contract 204 notifies the personal data owner of the use requirement. After receiving the notification, the personal data owner accesses the use authorization interface 302 to either consent to or reject the use requirement or to modify the use requirement and consent to the modified use requirement. If the personal data owner consents to the use requirement or modifies the use requirement and consents to the modified use requirement, the use authorization interface 302 activates the second smart contract 304. The second smart contract 304 generates an authorization credential based on a blockchain token and links the authorization credential to a blockchain wallet 50 of the personal data requester.

A third decentralized application 40 includes a personal data access interface 402 at a front end and a third smart contract 404 at a back end. The personal data access interface 402 runs on a third server 108 for the personal data requester to submit a request for accessing the personal data of the personal data owner. The third server 108 is one of the nodes 102, and the personal data access interface 402 may be an application running on the third server 108 that provides data access, for example, through an API. The personal data requester uses the personal data access interface 402 through a query program on a computer or other device.

When the personal data requester submits a request for accessing the personal data of the personal data owner through the personal data access interface 402, the personal data access interface 402 invokes a third smart contract 404 corresponding thereto. The third smart contract 404 will verify whether the blockchain wallet 50 of the personal data requester is linked to the authorization credential created by the personal data owner and complies with the content of the use requirement recorded in the authorization credential. After the verification, the third smart contract 404 decrypts and combines relevant personal data stored in the blockchain and then provides the decrypted and combined data to the personal data requester through the personal data access interface 402. When the third smart contract 404 discovers that the authorization credential associated with the blockchain wallet 50 of the personal data requester is invalid, the third smart contract 404 will automatically burn the token of the authorization credential.

The personal data owner may also submit a request for cancelling previously created and still-invalid use authorization at any time through the use authorization interface 302. In the present embodiment, the token of the created use authorization is also burned through the second smart contract 304 of the use authorization interface 302.

The personal data requester can modify the created and still-valid use authorization at any time through the aforementioned use authorization interface 302. In the present embodiment, the second smart contract 304 of the use authorization interface 302 first burns the token of the previously created use authorization and then creates a new authorization credential based on a blockchain token and links the new authorization credential to the blockchain wallet 50 of the personal data requester. The new authorization credential records the content of the modified use requirement.

The third server 108 and first server 104 (or the second server 106) can be included in a single server. The third smart contract 404 and the first smart contract 204 (or the second smart contract 304) can be included in a single smart contract. The third smart contract 404 is stored in the blockchain with a copy stored on each node 102.

It should be noted that the spirit and nature of the present disclosure will be more clearly described by the detailed descriptions of the embodiments, and the scope of the present disclosure should not be limited to the embodiments disclosed above. On the contrary, the objective is to cover various modifications and equivalent arrangements included within the scope of the claims appended to the present disclosure.

What is claimed is:

1. A method for dynamically authorizing personal data based on a blockchain, which enables a personal data owner to dynamically authorize a personal data requester to access personal data stored in the blockchain, the method comprising:
receiving a use requirement, submitted by the personal data requester through a requirement application interface, for using the personal data of the personal data owner;
notifying the personal data owner of the use requirement;
receiving a grant made by the personal data owner through a use authorization interface or receiving the grant after the use requirement is modified by the personal data owner through the use authorization interface;
generating an authorization credential based on a blockchain non-fungible token in response to the use requirement and linking the authorization credential to a blockchain wallet of the personal data requester;
receiving a request, submitted by the personal data requester through a personal data access interface, for accessing the personal data of the personal data owner;
verifying that the blockchain wallet of the personal data requester is provided with the authorization credential created by the personal data owner; and
providing the personal data stored in the blockchain to be accessed by the personal data requester after the authorization credential is successfully verified.

2. The method of claim 1, further comprising:
automatically burning the authorization credential when the personal data access interface discovers that the authorization credential is invalid.

3. The method of claim 1, further comprising:
receiving a request, submitted by the personal data owner through the use authorization interface, for burning the authorization credential; and
burning the authorization credential.

4. The method of claim 1, further comprising:
receiving a request, submitted by the personal data owner through the use authorization interface, for modifying the use requirement;
burning the authorization credential; and
generating a second authorization credential based on the blockchain non-fungible token in response to the modified use requirement and linking the second authorization credential to the blockchain wallet of the personal data requester.

5. The method of claim 1, wherein the blockchain is a public blockchain, a private blockchain, a hybrid blockchain, or a consortium blockchain.

6. The method of claim 1, wherein the blockchain comprises a single chain or multiple chains.

7. The method of claim 1, wherein the use requirement comprises parts or entirety of the personal data to be used, a purpose of use, a date and time range of use, and a number of times of use.

8. The method of claim 1, wherein the authorization credential is a non-tradable soul-bound non-fungible token.

9. The method of claim 1, wherein the requirement application interface, the use authorization interface, and the personal data access interface are provided by decentralized applications respectively or by a single decentralized application.

10. The method of claim 9, wherein each of the decentralized applications utilizes a corresponding smart contract to implement functions of the requirement application interface, the use authorization interface, and the personal data access interface.

11. A system for dynamically authorizing personal data based on a blockchain, which enables a personal data owner to dynamically authorize a personal data requester to access personal data, the system comprising:
a blockchain comprising a plurality of nodes, wherein the personal data of the personal data owner is added to and stored in the nodes of the blockchain according to a block building procedure for the blockchain;
a first decentralized application comprising a requirement application interface at a front end and a first smart contract at a back end, wherein the requirement application interface is configured for the personal data requester to apply for a use requirement for using the personal data of the personal data owner, the first smart contract is configured to notify the personal data owner of the use requirement, and the first smart contract is stored in each of the nodes;
a first server, which is one of the plurality of nodes and configured to run the requirement application interface;
a second decentralized application comprising a use authorization interface at a front end and a second smart contract at a back end, wherein the use authorization interface is configured for the personal data owner to either consent to or reject the use requirement for using the personal data or for the personal data owner to modify the use requirement and consent to the modified use requirement, the second smart contract is configured to generate an authorization credential based on a blockchain non-fungible token and link the authorization credential to a blockchain wallet of the personal data requester, and the second smart contract is stored in each of the nodes;
a second server, which is one of the plurality of nodes and configured to run the use authorization interface;
a third decentralized application comprising a personal data access interface at a front end and a third smart contract at a back end, wherein the personal data access interface is configured to allow the personal data requester to submit a request for accessing the personal data of the personal data owner, and the third smart contract is configured to verify whether the blockchain wallet of the personal data requester is linked to the authorization credential created by the personal data owner and whether the request complies with a content of the use requirement recorded in the authorization credential, wherein after the verification, the third smart contract provides to the personal data requester the personal data of the personal data owner stored in the blockchain through the personal data access interface, and the third smart contract is stored in each of the nodes; and
a third server, which is one of the plurality of nodes and configured to run the personal data access interface.

12. The system of claim 11, wherein the third smart contract is further configured to automatically burn the authorization credential when the third smart contract discovers that the authorization credential is invalid.

13. The system of claim 11, wherein the second smart contract is configured to burn the authorization credential after the use authorization interface receives a request from the personal data owner for burning the authorization credential.

14. The system of claim 11, wherein the second smart contract is further configured to burn the authorization credential after the use authorization interface receives a request from the personal data owner for modifying the use requirement; and
generate a second authorization credential based on the blockchain non-fungible token in response to the modified use requirement and link the second authorization credential to the blockchain wallet of the personal data requester.

15. The system of claim 11, wherein the blockchain is a public blockchain, a private blockchain, a hybrid blockchain, or an alliance chain.

16. The system of claim 11, wherein the blockchain comprises a single chain or multiple chains.

17. The method of claim 11, wherein the use requirement comprises parts or entirety of the personal data to be used, a purpose of use, a date and time range of use, and a number of times of use.

18. The system of claim 11, wherein the authorization credential is a non-tradable soul-bound non-fungible token.

19. The system of claim 11, wherein the first server, the second server, and the third server are included in a single server.

20. The system of claim 11, wherein the first smart contract, the second smart contract, and the third smart contract are included in a single smart contract.
